(19) United States
(12) Patent Application Publication
(10) Pub. No.: US 2006/0171137 A1
(43) Pub. Date: Aug. 3, 2006

(54) Ring-shaped light emitting unit

(75) Inventor: Makoto Tamaki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 11/340,621

(22) Filed: Jan. 27, 2006

(30) Foreign Application Priority Data
Jan. 28, 2005 (JP) P2005-022278
Nov. 4, 2005 (JP) P2005-320237

(51) Int. Cl. G01D 11/28

(52) U.S. Cl. 362/26

(57) ABSTRACT

A ring-shaped light emitting unit including a ring-shaped light guiding member having a light emitting surface which is continuous along an extending direction thereof, and n light guiding paths for guiding light of a light source into the ring-shaped light guiding member, the n light guiding paths being continuously connected to portions of an outer periphery of the ring-shaped light guiding member at positions rotationally symmetrical about a center of the ring-shaped light guiding member as a reference, wherein an inner periphery of the ring-shaped light guiding member is a substantially perfectly round circle in a plan view, and the outer periphery of the ring-shaped light guiding member has a shape in which circular arcs of a plurality of substantially perfectly round circles are continuously connected in a plan view, excluding light entering portions.

This application is based on Japanese Patent Applications No. 2005-022278 and 2005-320237, which are incorporated herein by reference.

### BACKGROUND OF THE INVENTION

1. Field of the Invention

The present invention relates to a ring-shaped light emitting unit. The present invention is used in the decoration of, for example, a speaker grill, a clock, or the like, or such as a speedometer or a tachometer of a vehicle (an automobile, an electric car, etc.), aircraft, or the like.

2. Description of the Related Art

Against the backdrop that it has become possible to utilize compact light sources of low electric power consumption, such as LEDs, and against the backdrop of improvement in consumers' design awareness, attempts have been made to decorate various objects (e.g., vehicle upholstery products) with light. As one of such attempts, a light emitting unit has been developed in which ring-like light is obtained by using a ring-shaped light guiding member and a light source in combination. An example of the ring-shaped light emitting units which have hitherto been proposed is shown in FIG. 10 (refer to JP-A-2004-14122). In the example of FIG. 10, a light guiding path 53 for introducing the light from a light source 52 is formed in such a manner as to continue to an outer peripheral portion of a ring-shaped light guiding member 51. As a result, the light of the light source 52 passes through the light guiding path 53 and is introduced into the ring-shaped light guiding member 51 from the circumferential direction (tangential direction). According to such a light guiding system, it is possible to allow the introduced light to travel efficiently along the direction in which the ring-shaped light guiding member 51 extends. However, in the process in which the light travels through the ring-shaped light guiding member 51, part of the light is lost, so that a portion in the vicinity of the light entering portion inevitably radiates brightly, and the light becomes the darker the further away from the vicinity of the light entering portion. As a countermeasure against this, a method is conceivable to gradually change the width of the light guiding member by changing the curvature of the outer periphery of the ring-shaped light guiding member, thereby compensating for the lack of luminance in a region away from the light entering portion. With this method, however, there is a problem in that the concentration of the light occurs due to the change in the curvature of the outer periphery, with the result that a bright line appears unfavorably.

On the other hand, as shown in FIGS. 11A and 11B, a method has been proposed in which the light is introduced from a lower surface 62 of a ring-shaped light guiding member 61 (refer to JP-A-2003-297107 and JP-A-2003-297108). In the method shown in FIG. 11A, the light from the light source 52 is directly introduced into the ring-shaped light guiding member 61. Then, light in left and right two directions is generated from the introduced light by the action of a light polarizing means 63. In the method shown in FIG. 11B, a light guiding path 66 is provided perpendicularly to the lower surface 62.of the ring-shaped light guiding member 61. In this structure, the light in left and right two directions is generated from the light introduced into the ring-shaped light guiding member 61 through the light guiding path 66 by the action of the light polarizing means 63. Thus, in these structures, the light is made to easily reach the entirety of the ring-shaped light guiding member 61 by making use of the light polarizing means 63. However, since the light polarizing means 63 is formed in the ring-shaped light guiding member 61, this constitutes a hindrance, and the light guiding action is affected, with the result that emission luminance becomes nonuniform.

### SUMMARY OF THE INVENTION

Against the above-described backdrop, an object of the invention is to provide a light emitting unit which is capable of generating ring-shaped light of uniform luminance. Another object of the invention is to provide a light emitting unit which is capable of emitting light of high luminance in addition to the uniformity of luminance. Still another object of the invention is to provide a light emitting unit which is capable of generating ring-shaped light which is free of a bright line (a region where the luminance is extremely high in comparison with other portions).

To attain at least one of the above objects, the ring-shaped light emitting unit in accordance with the invention has the following structure. Namely, a ring-shaped light emitting unit comprising a ring-shaped light guiding member having a light emitting surface which is continuous along an extending direction thereof, and a plurality of light guiding paths for guiding light of a light source into the ring-shaped light guiding member, the light guiding paths being continuously connected to portions of an outer periphery of the ring-shaped light guiding member at positions rotationally symmetrical about a center of the ring-shaped light guiding member as a reference, wherein an inner periphery of the ring-shaped light guiding member is a substantially perfectly round circle in a plan view, and the outer periphery of the ring-shaped light guiding member has a shape in which circular arcs of a plurality of substantially perfectly round circles are continuously connected in a plan view, excluding light entering portions, and wherein, assumed that a position of the light entering portion of a first light guiding path is a first light entering portion, a position of a light entering portion of a second light guiding path is a second light entering portion, and the outer periphery of the ring-shaped light guiding member between the first light entering portion and the second light entering portion is divided at a predetermined position, at least a first region on a first light entering portion side in the outer periphery of the ring-shaped light guiding member between the first light entering portion and the second light entering portion comprises a circular arc of a substantially perfectly round circle having a center at a position offset a predetermined distance from a center position of the inner periphery of the ring-shaped light guiding member toward an open end side of the first light guiding path.

In other words, a ring-shaped light emitting unit comprising a ring-shaped light guiding member having a light emitting surface which is continuous along an extending direction thereof, and n (where n is an integer of 2 or more) light guiding paths (a first light guiding path, a second light guiding path, a third light guiding path, . . . , an nth light guiding path) for guiding light of a light source into the ring-shaped light guiding member, the n light guiding paths being continuously connected to portions of an outer periphery of the ring-shaped light guiding member at positions rotationally symmetrical about a center of the ring-shaped light guiding member as a reference, wherein an inner periphery of the ring-shaped light guiding member is a substantially perfectly round circle in a plan view, and the outer periphery of the ring-shaped light guiding member has a shape in which circular arcs of a plurality of substantially perfectly round circles are continuously connected in a plan view, excluding light entering portions, and wherein, in the ring-shaped light guiding member, if it is assumed that a position of the light entering portion of the first light guiding path is L1, a position of the light entering portion of the second light guiding path is L2, a position of the light entering portion of the third light guiding path is L3, . . . , and a position of the light entering portion of the nth light guiding path is Ln, a predetermined region at least on an L1 side in the outer periphery between L1 and L2 comprises a circular arc of a substantially completely round circle 11 having a center at a position offset a predetermined distance from a center position of the inner periphery toward an open end side of the first light guiding path, a predetermined region at least on an L2 side in the outer periphery between L2 and L3 comprises a circular arc of a substantially completely round circle 12 having a center at a position offset a predetermined distance from the center position of the inner periphery toward an open end side of the second light guiding path, . . . , and a predetermined region at least on an Ln side in the outer periphery between Ln and L1 comprises a circular arc of a substantially completely round circle in having a center at a position offset a predetermined distance from the center position of the inner periphery toward an open end side of the nth light guiding path.

In the above-described structure, the outer periphery of the ring-shaped light guiding member has a shape in which circular arcs of substantially perfectly round circles are continuously connected, excluding regions (light entering portions) where the light guiding paths are connected. Accordingly, the continuity of the outer peripheral surface of the ring-shaped light guiding member becomes high, so that it is possible to prevent the concentration of the light (occurrence of a bright line) due to sudden changes in the shape of the outer peripheral surface and the curvature.

Meanwhile, as the radius of curvature of the outer periphery in a fixed region located forwardly in the light entering direction (traveling direction of the light), the light of high luminance immediately after the light entry can be reflected by a gently curved surface. Accordingly, it is possible to obtain excellent reflecting action and light guiding action in a region where the reflectivity of the outer periphery substantially affects the uniformity of the luminance of the entire ring-shaped light guiding member.

Meanwhile, as a result of the fact that the width (cross-sectional area) of the light guiding member at the light entering portion becomes appropriately wide, efficient introduction of the light is effected. Namely, the light utilization rate becomes high. In addition, since the width of the light guiding member at the light entering portion is appropriately wide, the optical density in the vicinity of the light entering portion does not become excessively high. Accordingly, the difference in the optical density in the light guiding member decreases.

In addition, in a fixed region located forwardly in the light entering direction, as viewed from the light entering portion, the width of the light guiding member gradually decreases (becomes gradually narrow) the further away from the light entering portion. Accordingly, between a region close to the light entering portion and a region distant therefrom, the quantity of light (the total quantity of light) which reaches the region differs depending on the distance from the light entering portion, but the difference in the optical density becomes small. Namely, the optical density of those regions is uniformalized. As a result, the reflectivity due to the outer peripheral surface is also uniformalized over the entire regions.

As a result of the fact that the above-described action is exhibited, the optical density of the interior of the ring-shaped light guiding member assumes a highly uniformalized state, and a high light utilization rate is accomplished, making it possible to obtain high-luminance ring-shaped light excelling in the luminance balance. Further, such a preferred form of luminescence can be realized with a simple structure.

### BRIEF DESCRIPTION OF THE DRAWINGS

FIG. 1 is a plan view illustrating an example (a mode in which n light guiding paths are provided) of a ring-shaped light guiding member and light guiding paths which are used in the invention;

FIG. 2 is a plan view illustrating an example (a mode in which two light guiding paths are provided) of the ring-shaped light guiding member and the light guiding paths which are used in the invention;

FIG. 3 is a plan view illustrating still another mode of the ring-shaped light guiding member and the light guiding paths which are used in the invention;

FIG. 4 is a perspective view illustrating a ring-shaped light emitting unit 1 in accordance with an embodiment of the invention;

FIG. 5 is a plan view of the ring-shaped light emitting unit 1;

FIG. 6 is a side elevational view of a light emitting portion 20 for making up the ring-shaped light emitting unit 1;

FIG. 7 is a cross-sectional view (a cross-sectional view taken along line VII-VII in FIG. 5) of the light emitting portion 20 for making up the ring-shaped light emitting unit 1;

FIG. 8 is a plan view illustrating a ring-shaped light emitting unit 2 in accordance with another embodiment of the invention;

FIG. 9 is a cross-sectional view taken along line IX-IX in FIG. 8;

FIG. 10 is a diagram illustrating an example of a related ring-shaped light emitting unit; and

FIGS. 11A and 11B are diagrams illustrating other examples of the related ring-shaped light emitting unit.

### DETAILED DESCRIPTION OF THE PREFERRED EMBODIMENTS

(Ring-Shaped Light Guiding Member)

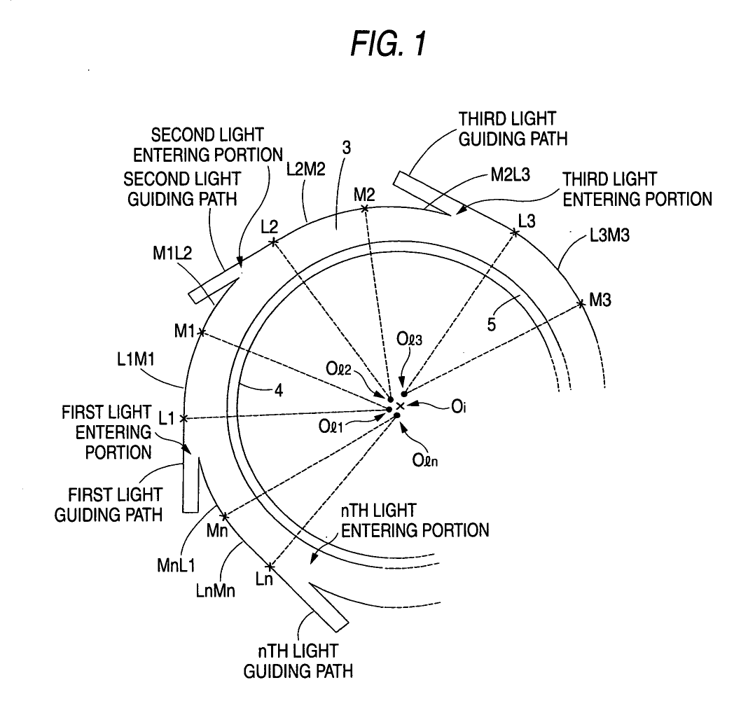

Referring to FIG. 1, a description will be given of the structure of a ring-shaped light guiding member. FIG. 1 is a plan view schematically illustrating a ring-shaped light guiding member in which n light guiding paths are connected. It should be noted that n is an integer of 2 or more, and is specifically 2, 3, 4, 5, 6, 7, 8, 9, or 10, for example.

An inner periphery 4 of a ring-shaped light guiding member 3 has a substantially completely round shape in a plan view. Meanwhile, an outer periphery of the ring-shaped light guiding, member 3 has a shape in which a plurality of substantially completely round circular arcs are continuously connected, excluding a first light entering portion (portion where a first light guiding path is connected), a second light entering portion (portion where a second light guiding path is connected), a third light entering portion (portion where a third light guiding path is connected), . . . , and an nth light entering portion (portion where an nth light guiding path is connected). Nth light guiding paths (referred to as the first light guiding path, the second light guiding path, the third light guiding path, . . . , and the nth light guiding path in that order in the clockwise direction) are connected to the ring-shaped light guiding member 3. The light guiding paths are connected at rotationally symmetrical positions by using as a reference the center (which coincides with a center Oᵢ of the inner periphery in this example) of the ring-shaped light guiding member 3. In addition, the light guiding paths are connected so as to be positioned at equal intervals.

For the sake of explanation, it is assumed that the position of the light entering portion of the first light guiding path is L1, the position of the light entering portion of the second light guiding path is L2, the position of the light entering portion of the third light guiding path is L3, . . . , and the position of the light entering portion of the nth light guiding path is Ln. In the ring-shaped light guiding member 3, a predetermined region at least on the L1 side in the outer periphery between L1 and L2 comprises a circular arc of a substantially completely round circle 11 having a center O₁₁ at a position offset a predetermined distance from the center position Oᵢ of the inner periphery 4 of the ring-shaped light guiding member toward the open end side of the first light guiding path (specifically, the side of the position L1 of the light entering portion). The remaining portions of the outer periphery also comprise circular arcs of specific substantially perfectly round circles in accordance with a similar rule (for example, a predetermined region at least on the Ln side in the outer periphery between Ln and L1 comprises a circular arc of a substantially completely round circle in having a center Oₗₙ at a position offset a predetermined distance from the center position Oᵢ of the inner periphery 4 of the ring-shaped light guiding member toward the open end side of the nth light guiding path).

The “predetermined region” referred to herein is a region which corresponds to, for instance, 40% to 100% of the entire outer periphery of the corresponding section. In accordance with one mode, the “predetermined region” is a region which corresponds to 100% of the entire periphery of the corresponding section. Accordingly, in this mode, the entire region of the outer periphery between L1 and L2, the entire region of the outer periphery between L2 and L3, . . . , and the entire region of the outer periphery between Ln and L1 respectively comprise circular arcs of substantially perfectly round circles in accordance with the aforementioned rule.

The distance between the center O₁₁ of the substantially perfectly round circle 11 defining a section L1L2 and the center Oᵢ of the inner periphery 4 (the amount of offset of the center) is for example, 2% to 15%, preferably 3% to 12% more preferably 4% to 10%, with respect to 100% of the radius of the inner periphery 4. If expressed by using the radius of the outer periphery between L1 and L2 as a reference, the amount of offset of the center is, for example, 2% to 12%, preferably 3% to 10%, more preferably 4% to 7%, with respect to 100% of the radius of that outer periphery. It is particularly preferred that the amount of offset of the center be included in both of the aforementioned range based on the radius of the inner periphery 4 as a reference and the aforementioned range based on the radius of the outer periphery between L1 and L2 as a reference. It should be noted that if the amount of offset of the center is too large, the width of the light guiding member in the vicinity of the first light entering portion becomes extremely wide, with the result that the light entering efficiency, the light guiding action between L1 and L2, and the like are affected, impairing the luminance balance of the ring-shaped light guiding member as a whole. If the amount of offset of the center is too small, it becomes impossible to sufficiently exhibit the advantage of the invention that the luminance is made uniform based on the fact the width of the light guiding member between L1 and L2 gradually decreases the further away from the first light entering portion.

Similarly, the distance between a center O₁₂ of a substantially perfectly round circle 12 defining a section L2L3 and the center Oᵢ of the inner periphery 4, the distance between a center O₁₃ of a substantially perfectly round circle 13 defining a section L3L4 and the center Oᵢ of the inner periphery 4, . . . , and the distance between a center Oₗₙ of a substantially perfectly round circle ln defining a section LnL1 and the center Oᵢ of the inner periphery 4 are also, for example, 2% to 15%, preferably 3% to 12%, more preferably 4% to 10%, with respect to 100% of the radius of the inner periphery 4. If expressed by using the radius of the respective section as a reference, the amount of offset of the center is, for example, 2% to 12%, preferably 3% to 10%, more preferably 4% to 7%, with respect to 100% of the radius of that outer periphery. It is particularly preferred that the amount of offset of the center be included in both of the aforementioned range based on the radius of the inner periphery 4 as a reference and the aforementioned range based on the radius of the outer periphery in each section as a reference. The reason that the amount of offset of the center preferably falls within the aforementioned ranges is the same as that for the case of L1L2. It should be noted that all the amounts of offset of the centers of the substantially perfectly round circles defining the respective sections should preferably be made identical. By so doing, the shape of the outer periphery of each section becomes equal, and the light guiding action becomes equivalent. As a result, the luminance balance improves further.

The aforementioned amount of offset of the center is set so that the ring-shaped light having small irregularities in luminance can be generated over the entirety. In other words, it is possible to finely adjust the amount of offset of the center while observing the luminance balance of the entire luminescence.

In another mode of the invention, the curvature of the outer periphery of each section changes midway. Specifically, In the ring-shaped light guiding member 3, if it is assumed that a specific position between L1 and L2 is M1, a specific position between L2 and L3 is M2, . . . , and a specific position between Ln and L1 is Mn, the outer periphery between L1 and M1 comprises a circular arc of the substantially perfectly round circle l1, the outer periphery between L2 and M2 comprises a circular arc of the substantially perfectly round circle l2, . . . , and the outer periphery between Mn and L1 comprises a circular arc of the substantially perfectly round circle ln. At the same time, the outer periphery between M1 and L2 comprises a circular arc of a substantially perfectly round circle (a substantially perfectly round circle m1) different from the substantially perfectly round circle 11, the outer periphery between M2 and L3 comprises a circular arc of a substantially perfectly round circle (a substantially perfectly round circle m2) different from the substantially perfectly round circle 12, . . . , and the outer periphery between Mn and L1 comprises a circular arc of a substantially type perfectly round circle (a substantially perfectly round circle mn) different from the substantially perfectly round circle ln. Thus, the outer periphery of the ring-shaped light guiding member 3 is divided into 2n sections including those between L1 and M1, between M1 and L2, between L2 and M2, between M2 and L3, . . . , between Ln and Mn, and between Mn and L1. Preferably, the substantially perfectly round circle m1, the substantially perfectly round circle m2, . . . , and the substantially perfectly round circle mn are identical, and their center coincides with the center Oᵢ of the inner periphery 4. In such a mode, the sections between M1 and L2, between M2 and L3, . . . , and between Mn and L1 are symmetrical about the center Oᵢ, and the forms of luminescence in those regions also have symmetry. Namely, the luminance balance improves further.

In the ring-shaped light emitting unit in accordance with the invention, the respective radii of curvature of the substantially perfectly round circle l1, the substantially perfectly round circle l2, . . . , and the substantially perfectly round circle ln, as well as the substantially perfectly round circle ln, the substantially perfectly round circle m1, the substantially perfectly round circle m2, . . . , and the substantially perfectly round circle mn assume the following relationship.

(the radius of curvature of the substantially perfectly round circle m1, the radius of curvature of the substantially perfectly round circle m2, . . . , and the radius of curvature of the substantially perfectly round circle mn)<(the radius of curvature of the substantially perfectly round circle l1, the radius of curvature of the substantially perfectly round circle l2, . . . , and the radius of curvature of the substantially perfectly round circle ln).

However, the radius of curvature of the substantially perfectly round circle l1, the radius of curvature of the substantially perfectly round circle l2, . . . , and the radius of curvature of the substantially perfectly round circle in should preferably be identical. Similarly, the radius of curvature of the substantially perfectly round circle m1, the radius of curvature of the substantially perfectly round circle m2, . . . , and the radius of curvature of the substantially perfectly round circle mn should preferably be identical. The reason is that the outer periphery is formed with the circular arcs of identical radii of curvature arranged alternately and rotationally symmetrically, so that the luminance balance improves further.

The ratio between the radius of curvature of the substantially perfectly round circle l1 and the radius of curvature of the substantially perfectly round circle m1 (the radius of curvature of the substantially perfectly round circle 11/the radius of curvature of the substantially perfectly round circle m1) is, for example, 1.01 to 1.2, preferably 1.02 to 1.1, more preferably 1.04 to 1.08. If the difference in the radius of curvature is too large, the width of the light guiding member in the vicinity of the first light entering portion becomes extremely large, with the result that the light entering efficiency, the light guiding action between L1 and M1, and the like are affected. On the other hand, if the difference in the radius of curvature is too small, it becomes impossible to sufficiently exhibit the advantage of the invention that the luminance is made uniform based on the fact the width of the light guiding member between L1 and M1 gradually decreases the further away from the first light entering portion.

Similarly, the ratio between the radius of curvature of the substantially perfectly round circle l2 and the radius of curvature of the substantially perfectly round circle m2 (the radius of curvature of the substantially perfectly round circle 12/the radius of curvature of the substantially perfectly round circle m2), . . . , and the ratio between the radius of curvature of the substantially perfectly round circle ln and the radius of curvature of the substantially perfectly round circle mn (the radius of curvature of the substantially perfectly round circle in/the radius of curvature of the substantially perfectly round circle mn) are also, for example, 1.01 to 1.2, preferably 1.02 to 1.1, more preferably 1.04 to 1.08.

The positions of M1 to Mn which divide the outer periphery of the ring-shaped light guiding member are not particularly limited. However, M1 to Mn should preferably be formed so that all of the distance between L1 and M1, the distance between L2 and M2, . . . , and the distance between Ln and Mn become all equal. The reason is that the luminance balance of the ring-shaped light guiding member as a whole improves. As one example of a specific positional relationship, it is possible to cite a mode in which M1 is located midway between L1 and L2, M2 is located midway between L2 and L3, . . . , and Mn is located midway between Ln and L1.

A light emitting surface is formed in the ring-shaped light guiding member in such a manner as to be continuous along its extending direction. If, for example, reflection treatment is provided in a partial region along the inner periphery of the lower surface of the ring-shaped light guiding member, the light is reflected by that region, and the light is fetched from an upper surface portion of the ring-shaped light guiding member which is located above that region. Thus, a portion of the upper surface of the ring-shaped light guiding member can be formed as the light emitting surface.

The cross-sectional shape of the ring-shaped light guiding member is not particularly limited. As examples of the cross-sectional shape, it is possible to cite a circle, an ellipse, a rectangle, a triangle, another polygon, a U-shape, and a shape which is formed by arbitrarily combining these shapes.

A half mirror layer can be formed on the light emitting surface of the ring-shaped light guiding member. By so doing, the light emitting surface portion is observed in a metallic color in cases where the outside illuminance is high such as during the daytime, making it possible to obtain a peculiar design feature and a sense of high quality. In addition, it is also possible to create an unexpected feature due to the fact that its design differs between the daytime and the nighttime.

The half mirror layer can be formed by a metal layer (Al, Ag, Au, etc.) of a predetermined film thickness. In addition, the half mirror layer can be formed by consecutively laminating such a metal layer and a protective layer formed of a light transmitting resin or the like. To illustrate one example of a method of forming such a half mirror layer, a metal layer constituted of a thin film of Al is first formed by vapor depositing Al on the surface of the light emitting surface. The metal layer is provided with such a thickness as to obtain the half mirror effect. For example, the thickness of the metal layer can be made such that the light transmittance becomes about 15 to 20%. Subsequently, a transparent resin such as epoxy resin is a protective layer is applied to the metal layer by printing, coating, or the like to thereby form a protective layer. It goes without saying that the structure of the half mirror layer and a method of formation thereof are not limited to these, and known ones can be adopted, respectively. Further, an ink layer can be provided such as on the surface of the protective layer or between the metal layer and the protective layer. The ink layer can be formed such as by printing or coating a color ink of yellow, for example.

A layer containing a fluorescent material can be formed on the light emitting surface of the ring-shaped light guiding member. By so doing, part of the light of the LED light source can be wavelength converted by the fluorescent material, and the color of the light radiated from the light emitting surface can be converted. Such a layer containing the fluorescent material can be formed such as by printing or coating ink containing a fluorescent material, or by adhering a sheet containing a fluorescent material. It should be noted that the fluorescent material can be contained in the protective layer or the ink layer which make up the half mirror layer.

The fluorescent material can also be contained in the ring-shaped light guiding member. In such a structure, fluorescence occurs in the ring-shaped light guiding member. It is possible to adopt an organic base or inorganic base fluorescent material by taking the form of fluorescence into consideration. If an organic base fluorescent material is used, it is possible to obtain a form of fluorescence which imparts a translucent look. On the other hand, if an inorganic base fluorescent material is used, it is possible to obtain a form of fluorescence which imparts a matted look.

The ring-shaped light guiding member can be fabricated by die molding or the like by molding a light transmitting material into a desired shape. As the light transmitting material, it is possible to use a synthetic resin such as polycarbonate, acrylic resin, epoxy resin, and urethane resin, or an inorganic material such as glass. The ring-shaped light guiding member may be formed of two or more materials. For example, it is possible to adopt a two-layered structure having a tubular clad and a core formed of a material having a higher refractive index than the forming material of the tubular clad.

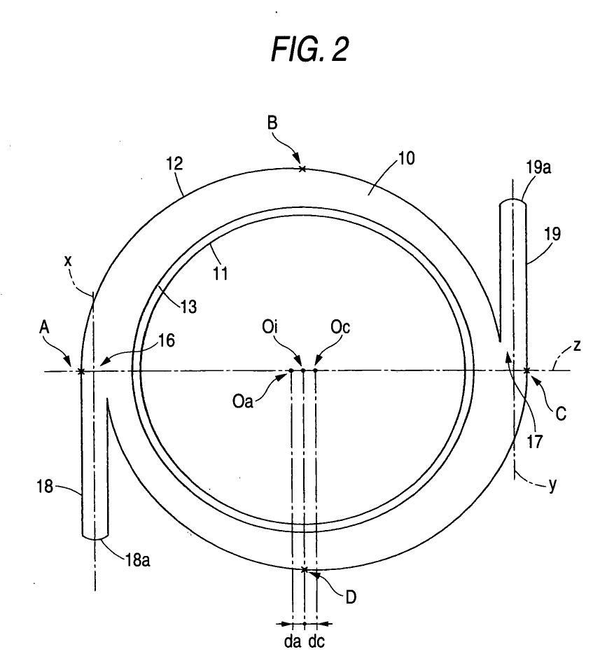

Hereafter, referring to FIG. 2, as one specific example of the ring-shaped light guiding member, a description will be given of a ring-shaped light guiding member 10 in which two light guiding paths are connected.

An inner periphery 11 of the ring-shaped light guiding member 10 has a substantially completely round shape in a plan view. Meanwhile, an outer periphery 12 of the ring-shaped light guiding member 10 has a shape in which two substantially completely round circular arcs are continuously connected, excluding light entering portions 16 and 17 (portions where light guiding path 18 and 19 are connected). Two light guiding paths (the first light guiding path 18 and the second light guiding path 19) are connected to the ring-shaped light guiding member 10. The first light guiding path 18 and the second light guiding path 19 are connected at symmetrical positions in a plan view by using as a reference the center (which coincides with the center of the inner periphery in this example) of the ring-shaped light guiding member 10.

If it is assumed that the position of the light entering portion of the first light guiding path 18 is A, the position of the light entering portion of the second light guiding path 19 is C, one of intermediate positions between A and C, which is located on the forward side in the light entering direction, as viewed from the light entering portion of the first light guiding path, is B, and the other intermediate position is D, then the outer periphery 12 of the ring-shaped light guiding member 10 is divided into four sections including a section AB, a section BC, a section CD, and a section DA. The section AB and the section BC comprise circular arcs of a substantially completely round circle a having a center Oₐ at a position offset a predetermined distance from the center position Oᵢ of the inner periphery 11 toward an open end 18a of the first light guiding path 18. The distance between the center Oₐ of the substantially perfectly round circle a defining the section AB and the section BC and the open end 18a of the first light guiding path 18 is shorter than the distance between the center Oᵢ of the inner periphery 11 and that open end 18a.

Meanwhile, the section CD and the section DA comprise circular arcs of a substantially completely round circle c having a center O_{c} at a position offset a predetermined distance from the center position Oᵢ of the inner periphery 11 toward an open end 19a of the second light guiding path 19.

As described above, the center Oₐ of the substantially perfectly round circle a defining the section AB and the section BC is offset (off-centered) in a predetermined direction as viewed from the center Oᵢ of the inner periphery 11. An imaginary straight line z connecting the center Oₐ of the substantially perfectly round circle a and the center Oᵢ of the inner periphery 11 should preferably be substantially perpendicular to a central axis x of the first light guiding path 18. In other words, the center Oₐ of the substantially perfectly round circle a should preferably be offset perpendicularly (leftwardly in the drawing) to the central axis x of the first light guiding path 18. According to such a design, the width of the light guiding member (distance between the outer periphery and the inner periphery) in the vicinity of the light entering portion 16 becomes appropriate for obtaining efficient light entry and excellent light guiding action. In addition, the width of the light guiding member gradually decreases from the position A to the position C through the position B. As a result, it is possible to prevent sudden changes in optical density and reflection action or in the light guiding action.

As for the section CD and the section DA, for the same reason as that for the section AB and the section BC, the imaginary straight line z connecting the center O_{c} of the substantially perfectly round circle c and the center Oᵢ of the inner periphery 11 should preferably be designed to be substantially perpendicular to a central axis y of the second light guiding path 19.

The distance da between the center Oₐ of the substantially perfectly round circle a defining the section AB and the section BC and the center Oᵢ of the inner periphery 11 (the amount of offset of the center) is, for example, 2% to 15%, preferably 3% to 12%, more preferably 4% to 10%, with respect to 100% of the radius of the inner periphery 11. If expressed by using the radius of the substantially perfectly round circle a as a reference, the amount of offset of the center is, for example, 2% to 12%, preferably 3% to 10%, more preferably 4% to 7%, with respect to 100% of the radius of the substantially perfectly round circle a. It is particularly preferred that the amount of offset of the center be included in both of the aforementioned range based on the radius of the inner periphery 11 as a reference and the aforementioned range based on the radius of the substantially perfectly round circle a as a reference. It should be noted that if the amount of offset of the center is too large, the width of the light guiding member in the vicinity of the light entering portion 16 becomes extremely wide, with the result that the light entering efficiency, the light guiding action between A and B and between B and C, and the like are affected, impairing the luminance balance of the ring-shaped light guiding member as a whole. If the amount of offset of the center is too small, it becomes impossible to sufficiently exhibit the advantage of the invention that the luminance is made uniform based on the fact the width of the light guiding member between A and B and between B and C gradually decreases the further away from the light entering portion 16.

Meanwhile, similarly, the distance dc between the center O_{c} of the substantially perfectly round circle c defining the section CD and the section DA and the center Oᵢ of the inner periphery 11 (the amount of offset of the center) is, for example, 2% to 15%, preferably 3% to 12%, more preferably 4% to 10%, with respect to 100% of the radius of the inner periphery 11: If expressed by using the radius of the substantially perfectly round circle c as a reference, the amount of offset of the center is, for example, 2% to 12%, preferably 3% to 10%, more preferably 4% to 7%, with respect to 100% of the radius of that substantially perfectly round circle c. It is particularly preferred that the amount of offset of the center be included in both of the aforementioned range based on the radius of the inner periphery 11 as a reference and the aforementioned range based on the radius of the substantially perfectly round circle c as a reference. The reason that the amount of offset of the center preferably falls within the aforementioned ranges is the same as that for the case of the section AB and the section BC. It should be noted that the amount of offset of the center, da, concerning the substantially perfectly round circle a and the amount of offset of the center, dc, concerning the substantially perfectly round circle c should preferably be made equal. If the outer peripheral shapes become equal, the light guiding action in the section AB and the section BC and the light guiding action in the CD and the section DA become equivalent. As a result, the luminance balance improves further.

The aforementioned amount of offset of the center is set so that the ring-shaped light having small irregularities in luminance can be generated over the entirety. In other words, it is possible to finely adjust the amount of offset of the center while observing the luminance balance of the entire luminescence.

The radius of curvature of the substantially perfectly round circle a and the radius of curvature of the substantially perfectly round circle c should preferably be identical. The reason is that the outer periphery 12 is formed with the circular arcs of identical radii of curvature arranged symmetrically, so that the luminance balance improves further.

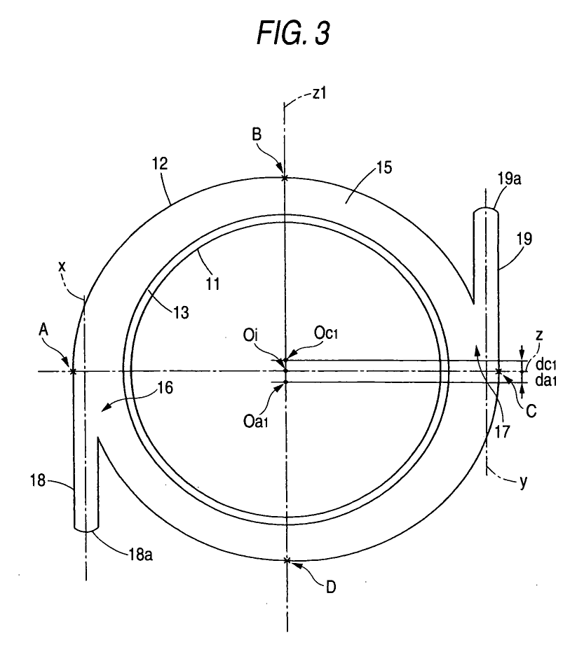

Here, still another mode of the ring-shaped light guiding member is shown in FIG. 3. In this ring-shaped light guiding member 15, the outer periphery 12 is divided into four sections including the section AB, the section BC, the section CD, and the section DA. The respective sections are respectively formed by circular arcs of specific substantially completely round circles. The section AB comprises a circular arc of a substantially completely round circle a1 having a center Oₐ₁ at a position offset a predetermined distance from the center position Oᵢ of the inner periphery 11 toward the open end 18a of the first light guiding path 18. The distance between the center Oₐ₁ of the substantially perfectly round circle a1 defining the section AB and the open end 18a of the first light guiding path 18 is shorter than the distance between the center Oᵢ of the inner periphery 11 and that open end 18a. Similarly, the section CD comprises a circular arc of a substantially completely round circle c1 having a center O_{c1} at a position offset a predetermined distance from the center position Oᵢ of the inner periphery 11 toward the open end 19a of the second light guiding path 19. Meanwhile, the section BC and the section DA also comprise circular arcs of substantially completely round circles (for the sake of explanation, a substantially perfectly round circle defining the section BC is set as a substantially perfectly round circle b, and a substantially perfectly round circle defining the section DA is set as a substantially perfectly round circle d). In FIG. 3, the substantially perfectly round circles defining both sections are identical, and their center coincides with the center Oᵢ of the inner periphery 11. In such a mode, the section BC and the section DA are symmetrical about the center Oᵢ of the inner periphery 11, and the form of luminescence in these regions also has symmetry. In other words, the luminance balance improves further.

In the ring-shaped light guiding member 15, the center Oₐ₁ of the substantially perfectly round circle defining the section AB is offset (off-centered) in a downward direction in the drawing as viewed from the center Oᵢ of the inner periphery 11. In other words, an imaginary straight line z1 connecting the center Oₐ₁ of the substantially perfectly round circle defining the section AB and the center Oᵢ of the inner periphery 11 is substantially parallel to the central axis x of the first light guiding path 18. According to such a design as well, the width of the light guiding member (distance between the outer periphery and the inner periphery) in the vicinity of the light entering portion 16 becomes wide, making it possible to obtain efficient light entry and excellent light guiding action. In addition, the width of the light guiding member gradually decreases from the position A toward the position B. As a result, it is possible to prevent sudden changes in optical density and reflection action or in the light guiding action.

As for the section CD, for the same reason as that for the section AB, the imaginary straight line z1 connecting the center O_{c1} of the substantially perfectly round circle and the center Oᵢ of the inner periphery 11 is designed to be substantially parallel to the central axis y of the second light guiding path 19.

The distance da1 between the center Oₐ₁ of the substantially perfectly round circle a1 defining the section AB and the center Oᵢ of the inner periphery 11 (the amount of offset of the center) is, for example, 2% to 15%, preferably 3% to 12%, more preferably 4% to 10%, with respect to 100% of the radius of the inner periphery 11. If expressed by using the radius of the substantially perfectly round circle a1 as a reference, the amount of offset of the center is, for example, 2% to 12%, preferably 3% to 10%, more preferably 4% to 7%, with respect to 100% of the radius of that outer periphery. It is particularly preferred that the amount of offset of the center be included in both of the aforementioned range based on the radius of the inner periphery 11 as a reference and the aforementioned range based on the radius of the substantially perfectly round circle a1 as a reference. It should be noted that if the amount of offset of the center is too large, the width of the light guiding member in the vicinity of the light entering portion 16 becomes extremely wide, with the result that the light entering efficiency, the light guiding action between A and B, and the like are affected, impairing the luminance balance of the ring-shaped light guiding member as a whole. If the amount of offset of the center is too small, it becomes impossible to sufficiently exhibit the advantage of the invention that the luminance is made uniform based on the fact the width of the light guiding member between A and B gradually decreases the further away from the light entering portion 16.

Meanwhile, similarly, the distance dc1 between the center O_{c1} of the substantially perfectly round circle c1 defining the section CD and the center Oᵢ of the inner periphery 11 (the amount of offset of the center) is, for example, 2% to 15%, preferably 3% to 12%, more preferably 4% to 10%, with respect to 100% of the radius of the inner periphery 11. If expressed by using the radius of the substantially perfectly round circle c1 as a reference, the amount of offset of the center is, for example, 2% to 12%, preferably 3% to 10%, more preferably 4% to 7%, with respect to 100% of the radius of that substantially perfectly round circle c1. It is particularly preferred that the amount of offset of the center be included in both of the aforementioned range based on the radius of the inner periphery 11 as a reference and the aforementioned range based on the radius of the substantially perfectly round circle c1 as a reference. The reason that the amount of offset of the center preferably falls within the aforementioned ranges is the same as that for the case of the section AB. It should be noted that the amount of offset of the center, da1, concerning the substantially perfectly round circle a1 and the amount of offset of the center, dc1, concerning the substantially perfectly round circle c1 should preferably be made equal. If the outer peripheral shapes become equal, the light guiding action between A and B and the light guiding action between C and D become equivalent. As a result, the luminance balance improves further.

The aforementioned amount of offset of the center is set so that the ring-shaped light having small irregularities in luminance can be generated over the entirety. In other words, it is possible to finely adjust the amount of offset of the center while observing the luminance balance of the entire luminescence.

In the ring-shaped light emitting unit in accordance with the invention, the respective radii of curvature of the substantially perfectly round circles a1, b, c1, and d assume the following relationship.

(the radius of curvature of the substantially perfectly round circle b, the radius of curvature of the substantially perfectly round circle d)<(the radius of curvature of the substantially perfectly round circle a1, the radius of curvature of the substantially perfectly round circle c1).

However, the radius of curvature of the substantially perfectly round circle a1 and the radius of curvature of the substantially perfectly round circle c1 should preferably be identical. Similarly, the radius of curvature of the substantially perfectly round circle b and the radius of curvature of the substantially perfectly round circle d should preferably be identical. The reason is that the outer periphery is formed with the circular arcs of identical radii of curvature arranged symmetrically, so that the luminance balance improves further.

The ratio between the radius of curvature of the substantially perfectly round circle a1 and the radius of curvature of the substantially perfectly round circle b (the radius of curvature of the substantially perfectly round circle a1/the radius of curvature of the substantially perfectly round circle b) is, for example, 1.01 to 1.2, preferably 1.02 to 1.1, more preferably 1.04 to 1.08. If the difference in the radius of curvature is too large, the width of the light guiding member in the vicinity of the light entering portion 16 becomes extremely large, with the result that the light entering efficiency, the light guiding action between A and B, and the like are affected. On the other hand, if the difference in the radius of curvature is too small, it becomes impossible to sufficiently exhibit the advantage of the invention that the luminance is made uniform based on the fact the width of the light guiding member between A and B gradually decreases the further away from the light entering portion 16.

For a similar reason, the ratio between the radius of curvature of the substantially perfectly round circle c1 and the radius of curvature of the substantially perfectly round circle d (the radius of curvature of the substantially perfectly round circle c1/the radius of curvature of the substantially perfectly round circle d) is also, for example, 1.01 to 1.2, preferably 1.02 to 1.1, more preferably 1.04 to 1.08.

(Light Guiding Path)

The light guiding path is connected continuously to a portion of the outer periphery of the ring-shaped light guiding member. It is preferable to adopt a light guiding path whose central axis is parallel to or overlaps with the central axis of the ring-shaped light guiding member in the vicinity of the light entering portion thereof. According to such a light guiding path, it becomes possible to introduce the light from the light source efficiently in the extending direction of the ring-shaped light guiding member directly or by making use of the reflection by the outer periphery of the light guiding path. Accordingly, a high light utilization rate and excellent light guiding action are obtained.

The light guiding path can be connected so that the central axis of the light guiding path intersects the upper surface and the lower surface of the ring-shaped light guiding member at an acute angle. In such a structure, it becomes easy for the introduced light to be totally reflected by the upper surface or the lower surface of the ring-shaped light guiding member, making it possible to obtain excellent light guiding action. The “acute angle” referred to herein is, for example, about 65′ or less, preferably about 45′ or less, more preferably 30° or less, even more preferably about 20′ or less. Specifically, the “acute angle” can be set in the range of about 5′ to about 65′, the range of about 10° to about 45°, the range of about 10′ to about 30′, or the range of about 15′ to about 20′. It should be noted that since the angle of total reflection differs depending on the material, the material of the ring-shaped light guiding member (and the material of the light guiding path) can be taken into consideration in the setting of the angle here.

On the other hand, the light guiding path can also be connected so that the central axis of the light guiding path becomes parallel to the upper surface and the lower surface of the ring-shaped light guiding member. In such a mode, it is possible to effectively prevent the light introduced into the ring-shaped light guiding member through the light guiding path from being directed directly to the upper surface or the lower surface of the ring-shaped light guiding member in the light entering portion or its vicinity, and excellent light guiding action is exhibited. In particular, according to such a structure, it is possible to prevent the light entering portion or its vicinity from emitting light with high luminance in comparison with other regions.

In addition to the above-described characteristic features, the light guiding path should preferably be connected to the ring-shaped light guiding member so that, in a plan view, the central axis of the ring-shaped light guiding member is parallel to or overlaps with the central axis of the ring-shaped light guiding member in the light entering portion. According to such a structure, the guiding of the light through the light guiding path is effected so that the introduced light travels efficiently in the direction of the central axis of the ring-shaped light guiding member in the light entering portion, i.e., in the extending direction of the ring-shaped light guiding member. Excellent light guiding action is thereby obtained, and the uniformalization of the luminance is further promoted. In addition, the utilization rate of the light is enhanced.

The light guiding path should preferably be connected to the ring-shaped light guiding member so that the light of the light source can be guided to the ring-shaped light guiding member in as lossless a state as possible. For example, a high light introduction rate can be attained by constructing the light guiding path integrally with the ring-shaped light guiding member, as will be described later in detail.

It should be noted that if a high light introduction rate can be ensured, the light guiding path may be connected to the ring-shaped light guiding member by an adhesive or the like. Still alternatively, the light guiding path can be connected to the ring-shaped light guiding member by such means as welding or fusion.

The light of the light source is introduced into the light guiding path. A light introducing surface is formed at an end portion of the light guiding path opposite to the side where the light guiding path is connected to the ring-shaped light guiding member. In such a structure, the light source, which will be described later, is installed so as to oppose that light introducing surface. A plurality of light introducing surfaces may be provided in correspondence with the number of light sources.

On the other hand, the light source may be incorporated in the light guiding path. Namely, the light guiding path and the light source may be constructed integrally. For example, such a structure can be realized by forming the light guiding path from a light conducting resin and by performing in-mold molding of an LED device.

The introduction of light into the light guiding path is effected directly from the light source or indirectly through a reflecting surface or the like. However, the use of the former method is preferable for such reasons as that the arrangement can be simple, and that there is no possibility of the loss of light due to the reflecting surface.

Insofar as the light of the below-described light source can be guided satisfactorily through the light guiding path, the material of the light guiding path is not particularly matter. Preferably, the light guiding path is formed of a light guiding member. More preferably, the light guiding path is formed of a material whose light refractive index is identical to that of the constituent material of the ring-shaped light guiding member. By so doing, it is possible to prevent the occurrence of the reflection or refraction of the light in the connecting portion between the light guiding path and the ring-shaped light guiding member. In addition, in the case where the light guiding path is formed of a material whose light refractive index is identical to that of the constituent material of the ring-shaped light guiding member, these members can be fabricated as an integrally constructed unit by such means as injection molding. Accordingly, the light guiding path and the ring-shaped light guiding member become completely continuous, so that extremely high light introducing efficiency can be obtained. In addition, an advantage can be obtained in terms of the manufacturing process and the manufacturing cost.

The shape of the light guiding path is set in the form of a cylinder, a triangular prism, a quadratic prism, or another polygonal prism. It is possible to adopt a light guiding path in which the cross-sectional shape and/or the cross-sectional area is not fixed.

In a case where the leakage of light through the outer periphery of the light guiding path is expected due to such as the properties of the constituent material, it is preferable to prevent the leakage of the light such as by forming a reflecting layer on the outer periphery of the light guiding path.

The reflecting material can be formed such as by printing, vapor depositing, or sputtering light reflective ink (e.g., white base ink) on the outer periphery of the light guiding path. In addition, the reflecting material can also be formed by adhering a white base tap. As the light reflective ink and the white base tape, it is preferable to use those having high refractive indices with respect to the light of the below-described light source. The reflecting surface can also be formed by coarsening a part of the light guiding member surface making up the light guiding path by such treatment as etching, sand blasting, or electric discharge machining. Furthermore, the reflecting surface can also be formed by disposing a member whose surface has a high refractive index (e.g., a white resin, or a resin plated with such as Ag or Al on its surface) in a state of being in close contact with the outer periphery of the light guiding path.

(Light Source)

The light source is not particular limited, and it is possible to use an LED device, a bulb, or the like. It is preferable to use the LED device, among others. The reason is that since the LED device is compact, the miniaturization of the apparatus can be attained. In addition, there are also advantages in that the heating value is small, and that the effect of heat on peripheral members (the light guiding path, the object to be decorated, etc.) can be reduced. Furthermore, there are additional advantages in that the driving electric power is small, and that the service life is long. The kind of the LED is not particularly limited, and it is possible to use various types of LED devices, including a round type, chip type, and the like. From the viewpoint of the miniaturization, it is preferable to adopt a chip type LED device.

The color of the light source can be selected arbitrarily. By using a plurality of light sources, it is possible to vary emission colors by controlling them. For example, if an LED device in which light emitting units of respective colors of red, green, and blue are mounted on one substrate is used, and the form of luminescence of the respective light emitting units is controlled, it is possible to emit desired colors. As a result, it is possible to construct an light emitting unit which emits desired colors.

To introduce the light of the light source effectively into the light guiding path, the light source should preferably be disposed in close proximity to or close contact with the light introducing surface of the light guiding path. Alternatively, the light source should preferably be disposed in the light guiding path. A plurality of light sources may be used for one light guiding path. Improvement in the emission luminance can be attained by using a plurality of light sources.

### FIRST EMBODIMENT

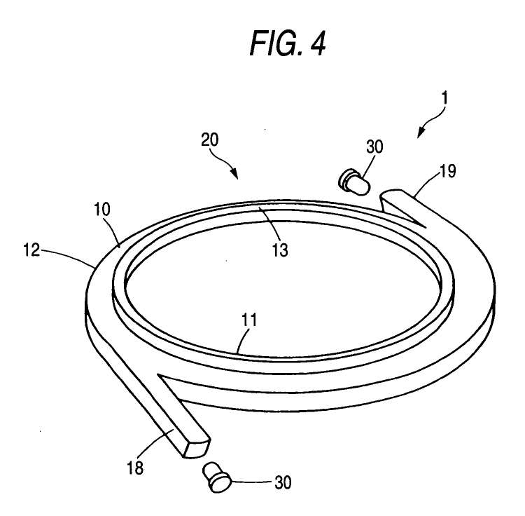

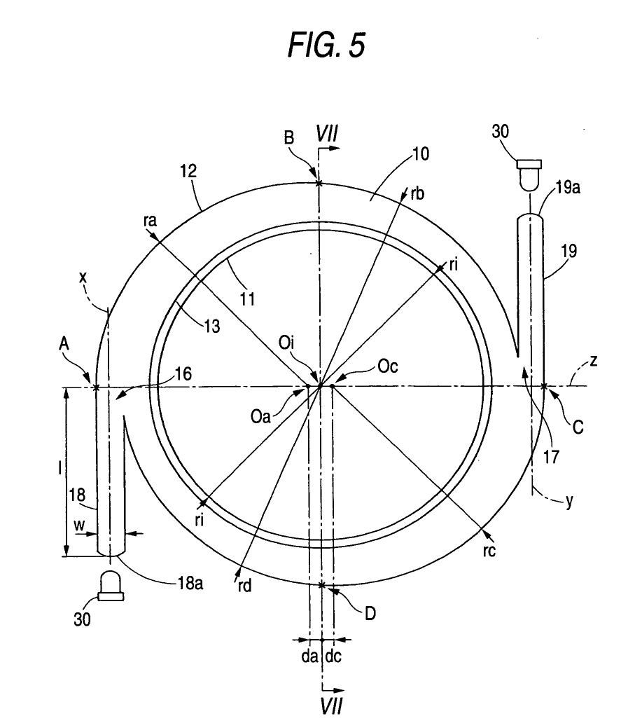

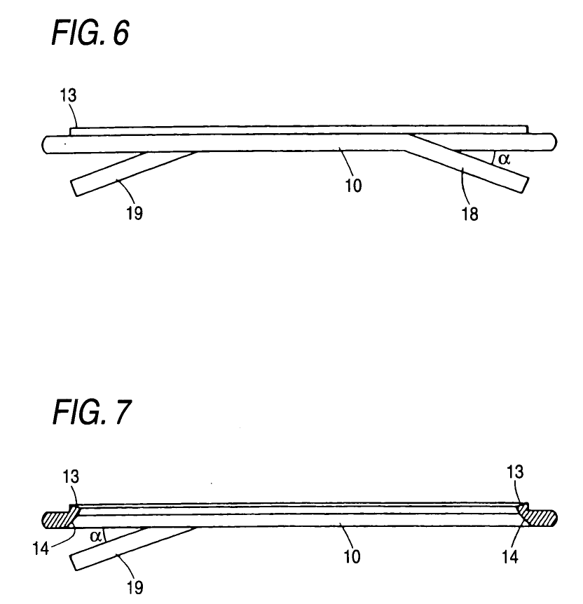

A ring-shaped light emitting unit in accordance with a first embodiment is shown FIGS. 4 to 7. FIG. 4 is a perspective view of a ring-shaped light emitting unit 1. FIG. 5 is a plan view thereof. FIG. 6 is a side elevational view of a light emitting portion (a ring-shaped light guiding member and light guiding paths) 20 of the ring-shaped light emitting unit 1. FIG. 7 is a vertical cross-sectional view of the light emitting portion 20 (a cross-sectional view taken along line VII-VII in FIG. 5). The ring-shaped light emitting unit 1 in accordance with this embodiment is used for decorating, for example, a periphery of a speaker grill. Hereafter, referring to the respective drawings, a description will be given of the structure and the form of luminescence of the ring-shaped light emitting unit 1.

The ring-shaped light emitting unit 1, if largely classified, is composed of the light emitting portion 20 and a light source 30. The light emitting portion 20 is composed of the integrally constructed ring-shaped light guiding member 10 and the two light guiding paths 18 and 19. The inner periphery 11 of the ring-shaped light guiding member 10 has a completely round shape in a plan view. Meanwhile, the outer periphery 12 of the ring-shaped light guiding member 10 has a plan view shape in which circular arcs of completely round circles are combined, excluding the light entering portions 16 and 17. Specifically, a section between A and B and a section between B and C of the outer periphery are circular arcs of a specific perfectly round circle a, and a section between C and D and a section between D and A are circular arcs of a specific perfectly round circle c. It is assumed that the position of the light entering portion of the first light guiding path 18 is A, the position of the light entering portion of the second light guiding path 19 is C, one of intermediate positions between A and C, which is located on the forward side in the light entering direction, as viewed from the light entering portion of the first light guiding path, is B, and the other intermediate position is D.

The perfectly round circle a defining the section AB and the section BC and the perfectly round circle c defining the section CD and the section DA are of the same size, and have a radius of about 95 mm. The center Oₐ of the substantially perfectly round circle a and the center O_{c} of the perfectly round circle c are respectively at positions offset (off-centered) from the center Oᵢ of the inner periphery 11 a predetermined distance in predetermined directions. Specifically, the center Oₐ of the perfectly round circle a is offset about 7 mm (distance da) in the leftward direction in the drawing so that the imaginary straight line z passing through the center Oᵢ of the inner periphery 11 is perpendicular to the central axis x of the light guiding path 18. In other words, Oₐ is located at a position which moved by that distance from Oᵢ in a perpendicular direction toward the central axis x of the light guiding path 18. The amount of this offset corresponds to about 10% of the radius ri (about 70 mm) of the inner periphery, and corresponds to about 7% of the radius ra (about 95 mm) of the perfectly round circle a defining the section AB.

Similarly, the center O_{c} of the perfectly round circle c is offset from Oi about 7 mm (distance dc) in a perpendicular direction (in the rightward direction in the drawing) to the central axis y of the light guiding path 19. The amount of this offset corresponds to about 10% of the radius ri (about 70 mm) of the inner periphery, and corresponds to about 7% of the radius rc (about 95 mm) of the perfectly round circle c defining the section CD. By designing as described above, the width of the light guiding member at the light entering portions 16 and 17 assumes an appropriate width, and the width of the light guiding member gradually decreases the further away from the light entering portion. Moreover, the continuity of the outer periphery of the light guiding member becomes high excluding the position of the light entering portion.

As described above, the outer periphery of the ring-shaped light guiding member 10 is formed such that circular arcs of perfectly round circles of different sizes are alternately arranged in a state in which the centers of the perfectly round circles defining them are offset.

The upper surface side of the ring-shaped light guiding member 10 is one step higher on the inner periphery 11 side (FIGS. 6 and 7). The upper surface of a projecting portion thereby formed is an inclined surface which is gradually inclined from the outer periphery 12 side toward the inner periphery 11 side. This inclined surface constitutes a light emitting surface 13. Meanwhile, an inclined surface 14 of about 45° is formed on the inner periphery 11 side of the lower surface side of the ring-shaped light guiding member 10 (FIG. 7). The surface of this inclined surface 14 is provided with embossing treatment. This imparts light reflectivity and light diffusivity to the inclined surface 14.

The ring-shaped light guiding member 10 has the pair of light guiding paths 18 and 19 which continue to portions of its outer periphery 12. The light guiding path 18 and the light guiding path 19 are connected so as to be symmetrical about the center Oᵢ of the ring-shaped light guiding member 10 in a plan view.

The cross sections of the light guiding paths 18 and 19 are both shaped in the form of a quadratic prism, and have a straight portion and a curved portion. The length of the light guiding path 18 in this embodiment is about 80 mm, and the width w is about 7 mm. As shown in FIGS. 6 and 7, the light guiding paths 18 and 19 are respectively connected at their one ends to the outer periphery 11 of the ring-shaped light guiding member 10 so as to assume a fixed angle α with respect to the lower surface of the ring-shaped light guiding member 10.

As a result, the light is introduced to the ring-shaped light guiding member 10 from diagonally below. The angle α here is about 20° in this embodiment. By connecting at such an acute angle, the introduced light can be made to travel efficiently in the extending direction of the ring-shaped light guiding member 10 while keeping the luminance balance of the light which is finally radiated from the light emitting surface 13 of the ring-shaped light guiding member 10.

In this embodiment, the light guiding paths 18 and 19 are constructed integrally with the ring-shaped light guiding member 10 (i.e., in a seamless state). The light guiding paths 18 and 19 are connected to the ring-shaped light guiding member 10 such that the central axes x and y of their straight portions become substantially parallel to the central axis of the ring-shaped light guiding member in the vicinities of the corresponding light entering portions (16, 17). It should be noted that although in this embodiment the respective light guiding paths are connected at a predetermined angle with respect to the lower surface of the ring-shaped light guiding member 10, the light guiding paths may be connected such that their central axes become parallel to the lower surface of the ring-shaped light guiding member 10.

In this embodiment, the light emitting portion (the ring-shaped light guiding member 10 and the light guiding paths 18 and 19) 20 is made of an acrylic resin. Such a light emitting portion 20 can be fabricated by molding (e.g., injection molding) using a mold corresponding to its shape.

The light sources 30 are respectively provided at positions opposing the open ends 18a and 19a of the light guiding paths 18 and 19. In this example, a round type (lens type) blue emitting LED device is used as the light source 30.

Next, a description will be given of the form of luminescence of the ring-shaped light emitting unit 1. First, the light emitted from the respective LED devices 30 is incident upon the open ends 18a and 19a of the light guiding paths 18 and 19. The light thus fetched into the light guiding paths 18 and 19 is guided in the light guiding paths 18 and 19, and is directed toward the ring-shaped light guiding member 10. The light then passes through the connecting portions (light entering portions 16 and 17) between each of the light guiding paths 18 and 19 and the ring-shaped light guiding member 10, and travels into the ring-shaped light guiding member 10. The light fetched into the ring-shaped light guiding member 10 through the light guiding path 18 passes through the section AB and the section BC, and is guided in the light guiding member 10 clockwise in the illustrated case in FIG. 4. Meanwhile, the light fetched into the ring-shaped light guiding member 10 through the light guiding path 19 passes through the section CD and the section DA, and is similarly guided in the light guiding member 10 clockwise in the illustrated case. The light thus travels in the ring-shaped light guiding member 10, and part of it is converted into upwardly directed light by being reflected by the inclined surface 14 (reflecting surface) on the lower surface side of the ring-shaped light guiding member 10. The light is finally radiated to the outside from the light emitting surface 13 of the ring-shaped light guiding member 10. As a result, the ring-shaped light is obtained.

Here, by designing the ring-shaped light guiding member 10 as described above, the outer periphery 12 of the light guiding member in the vicinities of the light entering portions 16 and 17 assumes a gently curved surface. Accordingly, the light of high luminance immediately after the light entry can be reflected by the gently curved surface Consequently, excellent light guiding action can be obtained. Meanwhile, as the width of the light guiding member in the vicinity of the light entering portion becomes wide, efficient introduction of the light is effected. Namely, the light utilization rate becomes high. In addition, since the width of the light guiding member in the vicinity of the light entering portion is appropriately wide, the optical density in the vicinity of the light entering portion does not become excessively high. In other words, the difference in optical density in the light guiding member decreases. In addition, since the width of the light guiding member gradually decreases the further away from the light entering portion, excellent light guiding action can be obtained, and the uniformalization of the optical density in the ring-shaped light guiding member 10 can be further attained. Furthermore, since an outer periphery which is highly continuous without entailing a sudden change in the curvature is formed, it is possible to prevent partial concentration of the light.

Meanwhile, since the structure provided is such that the light guiding paths 18 and 19 are connected such that their central axes x and y are parallel to the central axis of the light guiding member in the vicinities of the light entering portions, the light introduced through the respective light guiding paths 18 and 19 can be made to efficiently travel in the extending direction of the ring-shaped light guiding member 10. In addition, since the light guiding paths 18 and 19 are provided at symmetrical positions, the light can be guided into the ring-shaped light guiding member 10 with a good balance.

As a result of the fact that the above-described action is exhibited, the optical density of the ring-shaped light guiding member 10 assumes a highly uniformalized state, and a high light utilization rate is accomplished, making it possible to obtain high-luminance ring-shaped light excelling in the luminance balance. In particular, it is possible to prevent the occurrence of a bright line, and part of the light ceases to be observed with high luminance. As is apparent from the above-described embodiment, there is an advantage in that such a preferred form of luminescence can be realized with a simple structure.

Although in this embodiment the light emitting portion is provided with two light guiding paths, a light emitting portion having a greater number of, e.g., 3 or 4, light guiding paths may be constructed. In that case, the configuration of the outer periphery of the ring-shaped light guiding member is designed in accordance with a rule similar to the case in which two light guiding paths are provided. For example, in a case where three light guiding paths are provided, the light guiding paths are first arranged uniformly such that straight lines connecting the light guiding paths form a triangle. Then, the outer periphery is first divided at the position of the light entering portion of each light guiding path, and then at the position of a mid-point between two adjacent light entering portions. Six sections thus obtained will be referred to, in order, as a section A, a section B, a section C, a section D, a section E, and a section F (however, the sections A, C and E are sections in which the light entering portion is set as a starting point). Of these sections, three sections (A, C, and E) in which the light entering portion is set as the starting point are set as circular arcs of perfectly round circles each having a center at a position offset a predetermined distance in the direction toward the open end of the light guiding path connected to a corresponding light entering portion from the position of the center of the perfectly round circle defining the inner periphery of the light guiding member. The remaining three sections (B, D, and F) are set as circular arcs of perfectly round circles each having a center which coincides with the center of the perfectly round circle defining the inner periphery of the light guiding member. As a result, circular arcs in which the centers of the perfectly round circles defining them are identical appear alternately, and the circular arcs of the perfectly round circles having centers at positions which are offset from the center of the inner periphery of the ring-shaped light guiding member. According to the above-described design, excellent light guiding action and the like are exhibited in the same way as in the case where two light guiding paths are provided, making it possible to obtain high-luminance ring-shaped light excelling in the luminance balance.

### SECOND EMBODIMENT

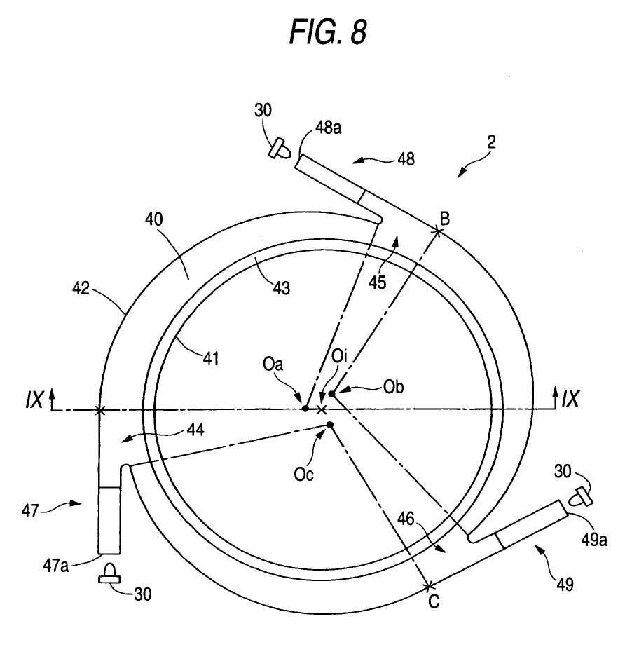

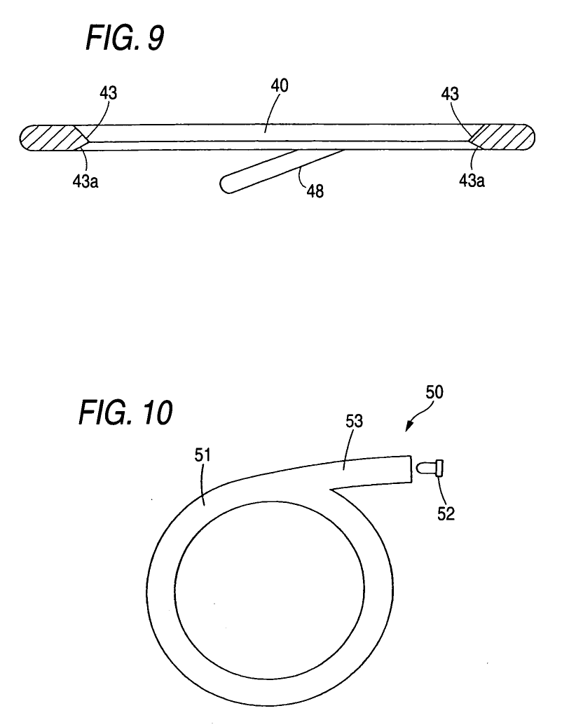

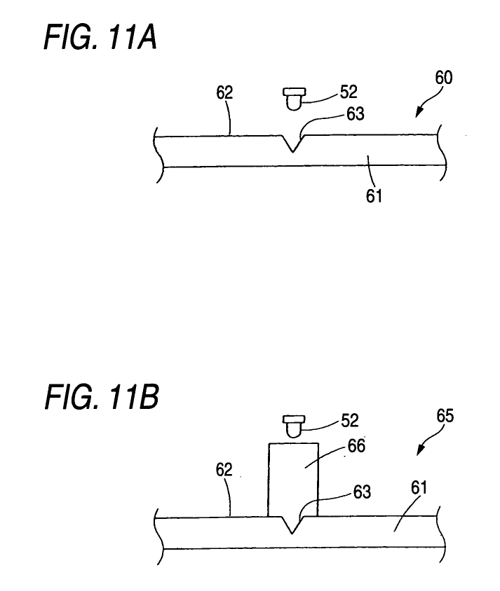

FIGS. 8 and 9 show a specific structure of a case in which the light emitting portion of the ring-shaped light emitting unit has three light guiding paths. FIG. 8 is a plan view illustrating a ring-shaped light emitting unit 2 in accordance with this embodiment. FIG. 9 is a cross-sectional view taken along line IX-IX in FIG. 8. Hereafter, referring to these drawings, a description will be given of the structure and the form of luminescence of the ring-shaped light emitting unit 2. It should be noted that matters which are not specifically referred to are assumed to be the same as those of the ring-shaped light emitting unit 1 of the above-described embodiment. In addition, those members and elements which are substantially identical to the ring-shaped light emitting unit 1 will be denoted by the same reference numerals, and a description thereof will be omitted partially.

The ring-shaped light emitting unit 2 is comprised of a light emitting portion including a ring-shaped light guiding member 40 and three light guiding paths 47 to 49, as well as three light sources 30. An inner periphery 41 of the ring-shaped light guiding member 40 has a completely round shape in a plan view. Meanwhile, an outer periphery 42 of the ring-shaped light guiding member 40 has a plan view shape in which circular arcs of three completely round circles are combined, excluding light entering portions 44 to 46. Specifically, an outer periphery between A and B (however, excluding the light entering portion 45), an outer periphery between B and C (however, excluding the light entering portion 46), and an outer periphery between C and A (however, excluding the light entering portion 44) are circular arcs of specific perfectly round circles. It is assumed that the position of the light entering portion of the light guiding path 47 is A, the position of the light entering portion of the light guiding path 48 is B, and the position of the light entering portion of the light guiding path 49 is C.

The perfectly round circle a defining the outer periphery between A and B, the perfectly round circle b defining the outer periphery between B and C, and the perfectly round circle c defining the outer periphery between C and A are of the same size, and have a radius of about 140 mm. The center Oₐ of the perfectly round circle a, the center O_{b} of the perfectly round circle b, and the center O_{c} of the perfectly round circle c are respectively at positions offset (off-centered) from the center Oᵢ of the inner periphery 41 a predetermined distance in predetermined directions. Specifically, the center Oₐ of the perfectly round circle a is offset about 10 mm so as to approach an open end 47a of the first light guiding path 47. More specifically, the center Oₐ of the perfectly round circle a is located at a position which moved about 10 mm from the center position Oᵢ of the inner periphery 41 toward the position A side. The amount of this offset corresponds to about 10% of the radius ri (about 100 mm) of the inner periphery 41, and corresponds to about 7% of the radius ra (about 140 mm) of the perfectly round circle a defining the outer periphery between A and B.

Similarly, the center O_{b} of the perfectly round circle b defining the outer periphery between B and C is offset about 10 mm so as to approach an open end 48a of the second light guiding path 48, and the center O_{c} of the perfectly round circle c defining the outer periphery between C and A is offset about 10 mm so as to approach an open end 49a of the third light guiding path 49. Specifically, the center O_{b} of the perfectly round circle b is located at a position which moved about 10 mm from the center position Oᵢ of the inner periphery 41 toward the position B side on a straight line connecting the center position Oᵢ of the inner periphery 41 and the position B, while the center O_{c} of the perfectly round circle c is located at a position which moved about 10 mm from the center position Oᵢ of the inner periphery 41 toward the position C side on a straight line connecting the center position Oᵢ of the inner periphery 41 and the position C.

By designing as described above, the width of the light guiding member at the light entering portions 44 and 46 assumes an appropriate width, and the width of the light guiding member gradually decreases the further away from the light entering portion.

An inner peripheral side edge portion of the upper surface side of the ring-shaped light guiding member 40 is an inclined surface which is inclined at about 45° toward the inner periphery 41 (FIG. 9). This inclined surface constitutes a light emitting surface 43. Meanwhile, an inclined surface 43a having an angle of inclination of about 30° is formed at an inner peripheral side edge portion of the lower surface side of the ring-shaped light guiding member 40. The surface of this inclined surface 43a is provided with crimping treatment. This imparts light reflectivity and light diffusivity to the inclined surface 43a.

As shown in FIG. 9, in the ring-shaped light guiding member 40 of this embodiment, its edges are shaped in curved forms. It is possible to adopt various edge shapes, such as an edge shape in which the edge surface is perpendicular to the upper surface of the ring-shaped light guiding member, and an edge shape in which the edge surface is inclined at a predetermined angle with respect to the upper surface of the ring-shaped light guiding member.

The light guiding paths 47 to 49 in a plan view are connected so as to be rotationally symmetrical about the center Oᵢ of the ring-shaped light guiding member 40 as a reference and at equal intervals.

Next, a description will be given of the form of luminescence of the ring-shaped light emitting unit 2. First, the light emitted from the respective LED devices 30 is incident upon the open ends 47a to 49a of the light guiding paths 47 to 49. The light thus fetched into the light guiding paths 47 to 49 is guided in the respective light guiding paths, and is directed toward the ring-shaped light guiding member 40. The light then passes through the connecting portions (light entering portions 44 to 46) between each light guiding path and the ring-shaped light guiding member 40, and travels into the ring-shaped light guiding member 40. The light fetched into the ring-shaped light guiding member 40 through the light guiding path 47 passes through the section AB, and is guided in the ring-shaped light guiding member 40 clockwise in the illustrated case in FIG. 8. Similarly, the light fetched through the light guiding path 48 and the light guiding path 49 is guided in the ring-shaped light guiding member 40. Thus, the light travels in the ring-shaped light guiding member 40, and is finally radiated to the outside from the light emitting surface 43 of the ring-shaped light guiding member 40. As a result, the ring-shaped light is obtained.

Here, by designing the ring-shaped light guiding member 40 as described above, the outer periphery of the light guiding member in the vicinities of the respective light entering portions assumes a gently curved surface. Accordingly, the light of high luminance immediately after the light entry can be reflected by the gently curved surface. Consequently, excellent light guiding action can be obtained. Meanwhile, as the width of the light guiding member in the vicinity of the light entering portion becomes wide, efficient introduction of the light is effected. Namely, the light utilization rate becomes high. In addition, since the width of the light guiding member in the vicinity of the light entering portion is appropriately wide, the optical density in the vicinity of the light entering portion does not become excessively high. In other words, the difference in optical density in the light guiding member decreases. In addition, since the width of the light guiding member gradually decreases the further away from the light entering portion, excellent light guiding action can be obtained, and the uniformalization of the optical density in the ring-shaped light guiding member 40 can be further attained. Furthermore, since an outer periphery which is highly continuous is formed, it is possible to prevent partial concentration of the light.

Meanwhile, since the light guiding paths 47 to 49 are provided at symmetrical positions, the light can be guided into the ring-shaped light guiding member 40 with a good balance.

As a result of the fact that the above-described action is exhibited, the optical density of the ring-shaped light guiding member 40 assumes a highly uniformalized state, and a high light utilization rate is accomplished, making it possible to obtain high-luminance ring-shaped light excelling in the luminance balance. In particular, it is possible to prevent the occurrence of a bright line, and part of the light ceases to be observed with high luminance. As is apparent from the above-described embodiment, there is an advantage in that such a preferred form of luminescence can be realized with a simple structure.

According to the invention, it is possible to obtain ring-shaped luminescence in which the luminance is uniformalized. The light excelling in such a decorative feature can be used for enhancing the design features of various objects. Specifically, the invention can be applied to the decoration of, for example, a speaker grill, a clock, or the like, or such as a speedometer or a tachometer of a vehicle (an automobile, an electric car, etc.), aircraft, or the like.

The invention is not limited to the description of the mode of carrying out the invention and the embodiments described above. The invention includes various modifications and changes without departing from the spirit and scope of the invention and within the scope readily conceivable by those skilled in the art.

The following matter is disclosed.

(1) A ring-shaped light emitting unit comprising:

a ring-shaped light guiding member having a light emitting surface which is continuous along an extending direction thereof; and

two light guiding paths for guiding light of a light source into the ring-shaped light guiding member, the light guiding paths including a first light guiding path and a second light guiding path which are continuously connected to portions of an outer periphery of the ring-shaped light guiding member at positions symmetrical about a center of the ring-shaped light guiding member,

wherein an inner periphery of the ring-shaped light guiding member is a substantially perfectly round circle in a plan view, and the outer periphery of the ring-shaped light guiding member has a shape in which circular arcs of a plurality of substantially perfectly round circles are continuously connected in a plan view, excluding light entering portions, and

wherein, in the ring-shaped light guiding member, if it is assumed that a position of the light entering portion of the first light guiding path is A, a position of the light entering portion of the second light guiding path is C, one of intermediate positions between A and C, which is located on a forward side in a light entering direction, as viewed from the light entering portion of the first light guiding path, is B, and another intermediate position is D,

the outer periphery between A and B comprises a circular arc of a substantially completely round circle a having a center at a position offset a predetermined distance from a center position of the inner periphery toward an open end side of the first light guiding path,

the outer periphery between B and C comprises a circular arc of a substantially completely round circle b,

the outer periphery between C and D comprises a circular arc of a substantially completely round circle c having a center at a position offset a predetermined distance from the center position of the inner periphery toward an open end side of the second light guiding path, and

the outer periphery between D and A comprises a circular arc of a substantially completely round circle d, the following relationship being satisfied:

(a radius of curvature of the substantially perfectly round circle b, a radius of curvature of the substantially perfectly round circle d)<(a radius of curvature of the substantially perfectly round circle a, a radius of curvature of the substantially perfectly round circle c).

(2) The ring-shaped light emitting unit according to (1) above, wherein the radius of curvature of the substantially perfectly round circle a and the radius of curvature of the substantially perfectly round circle scare equal, and the radius of curvature of the substantially perfectly round circle b and the radius of curvature of the substantially perfectly round circle d are equal.

(3) The ring-shaped light emitting unit according to (1) or (2) above, wherein both of a center of the substantially perfectly round circle b and a center of the substantially perfectly round circle d coincide with the center of the inner periphery.

(4) The ring-shaped light emitting unit according to any one of (1) to (3) above, wherein both of a distance between the center of the substantially perfectly round circle a and the center of the inner periphery and a distance between the center of the substantially perfectly round circle c and the center of the inner periphery are 2% to 15% with respect to 100% of a radius of the inner periphery.

(5) The ring-shaped light emitting unit according to any one of (1) to (3) above, wherein an imaginary straight line connecting the center of the substantially perfectly round circle a and the center of the inner periphery is substantially perpendicular to a central axis of the first light guiding path, and an imaginary straight line connecting the center of the substantially perfectly round circle c and the center of the inner periphery is substantially perpendicular to a central axis of the second light guiding path.

What is claimed is:

1. A ring-shaped light emitting unit comprising:
a ring-shaped light guiding member having a light emitting surface which is continuous along an extending direction thereof; and
a plurality of light guiding paths for guiding light of a light source into the ring-shaped light guiding member, the light guiding paths being continuously connected to portions of an outer periphery of the ring-shaped light guiding member at positions rotationally symmetrical about a center of the ring-shaped light guiding member as a reference,
wherein an inner periphery of the ring-shaped light guiding member is a substantially perfectly round circle in a plan view, and the outer periphery of the ring-shaped light guiding member has a shape in which circular arcs of a plurality of substantially perfectly round circles are continuously connected in a plan view, excluding light entering portions, and
wherein, assumed that a position of the light entering portion of a first light guiding path is a first light entering portion, a position of a light entering portion of a second light guiding path is a second light entering portion, and the outer periphery of the ring-shaped light guiding member between the first light entering portion and the second light entering portion is divided at a predetermined position, at least a first region on a first light entering portion side in the outer periphery of the ring-shaped light guiding member between the first light entering portion and the second light entering portion comprises a circular arc of a substantially perfectly round circle having a center at a position offset a predetermined distance from a center position of the inner periphery of the ring-shaped light guiding member toward an open end side of the first light guiding path.

2. The ring-shaped light emitting unit according to claim 1, wherein an entire region of the outer periphery of the ring-shaped light guiding member between the first light entering portion and the second light entering portion comprises a circular arc of the substantially perfectly round circle.

3. The ring-shaped light emitting unit according to claim 1, wherein a second region on a second light entering portion side in the outer periphery of the ring-shaped light guiding member between the first light entering portion and the second light entering portion comprises a circular arc of a substantially perfectly round circle having a radius of curvature larger than a radius of curvature of the substantially perfectly round circle in the first region.

4. The ring-shaped light emitting unit according to claim 3, wherein the first region and the second region are divided at an intermediate position between the first light entering portion and the second light entering portion.

5. The ring-shaped light emitting unit according to claim 3, wherein the outer periphery of the ring-shaped light emitting member is formed with the radius of curvature of the substantially perfectly round circle in the first region and the radius of curvature of the substantially perfectly round circle in the second region arranged alternately and rotationally symmetrically.

6. The ring-shaped light emitting unit according to claim 3, wherein a center of the substantially perfectly round circle in the second region coincides with the center of the inner periphery of the ring-shaped light guiding member.

7. The ring-shaped light emitting unit according to claim 1, wherein the central axis of each of the light guiding paths is parallel to or overlaps with the central axis of the ring-shaped light guiding member in a vicinity of a corresponding one of the light entering portions.

8. The ring-shaped light emitting unit according to claim 1, wherein the light guiding paths are formed of a same material as that of the ring-shaped light guiding member.

9. The ring-shaped light emitting unit according to claim 1, wherein the ring-shaped light guiding member and the light guides are integrally molded.

10. The ring shaped light emitting unit according to claim 1, wherein the light source comprises an LED.

11. A ring-shaped light emitting unit comprising:
a ring-shaped light guiding member having a light emitting surface which is continuous along an extending direction thereof; and
two light guiding paths for guiding light of a light source into the ring-shaped light guiding member, the light guiding paths including a first light guiding path and a second light guiding path which are continuously connected to portions of an outer periphery of the ring-shaped light guiding member at positions symmetrical about a center of the ring-shaped light guiding member,
wherein an inner periphery of the ring-shaped light guiding member is a substantially perfectly round circle in a plan view, and the outer periphery of the ring-shaped light guiding member has a shape in which circular arcs of two substantially perfectly round circles are continuously connected in a plan view, excluding light entering portions, and
wherein, if it is assumed that a position of the light entering portion of the first light guiding path is A, a position of the light entering portion of the second light guiding path is C, one of intermediate positions between A and C, which is located on a forward side in a light entering direction, as viewed from the light entering portion of the first light guiding path, is B, and another intermediate position is D, the ring-shaped light guiding member comprises:
an outer periphery between A and B and an outer periphery between B and C comprising circular arcs of a substantially completely round circle a having a center at a position offset a predetermined distance from a center position of the inner periphery toward an open end side of the first light guiding path; and
an outer periphery between C and D and an outer periphery between D and A comprising circular arcs of a substantially completely round circle c having a center at a position offset a predetermined distance from the center position of the inner periphery toward an open end side of the second light guiding path.

12. The ring-shaped light emitting unit according to claim 11 wherein a radius of curvature of the substantially perfectly round circle a and a radius of curvature of the substantially perfectly round circle c are equal.

13. The ring-shaped light emitting unit according to claim 11, wherein both of a distance between the center of the substantially perfectly round circle a and the center of the inner periphery and a distance between the center of the substantially perfectly round circle c and the center of the inner periphery are 2% to 15% with respect to 100% of a radius of the inner periphery.

14. The ring-shaped light emitting unit according to claim 11, wherein an imaginary straight line connecting the center of the substantially perfectly round circle a and the center of the inner periphery is substantially perpendicular to a central axis of the first light guiding path, and an imaginary straight line connecting the center of the substantially perfectly round circle c and the center of the inner periphery is substantially perpendicular to a central axis of the second light guiding path.

15. A ring-shaped light emitting unit comprising:
a ring-shaped light guiding member having a light emitting surface which is continuous along an extending direction thereof; and
three light guiding paths for guiding light of a light source into the ring-shaped light guiding member, the light guiding paths including a first light guiding path, a second light guiding path, and a third light guiding path which are continuously connected to portions of an outer periphery of the ring-shaped light guiding member at positions symmetrical about a center of the ring-shaped light guiding member,
wherein an inner periphery of the ring-shaped light guiding member is a substantially perfectly round circle in a plan view, and the outer periphery of the ring-shaped light guiding member has a shape in which circular arcs of three substantially perfectly round circles are continuously connected in a plan view, excluding light entering portions, and
wherein, if it is assumed that a position of the light entering portion of the first light guiding path is A, a position of the light entering portion of the second light guiding path is B, and a position of the light entering portion of the third light guiding path is C, the ring-shaped light guiding member comprises:
an outer periphery between A and B comprising a circular arc of a substantially completely round circle a having a center at a position offset a predetermined distance from a center position of the inner periphery toward an A side;
an outer periphery between B and C comprising a circular arc of a substantially completely round circle b having a center at a position offset a predetermined distance from the center position of the inner periphery toward a B side; and
an outer periphery between C and D comprising a circular arc of a substantially completely round circle c having a center at a position offset a predetermined distance from the center position of the inner periphery toward a C side.

16. The ring-shaped light emitting unit according to claim 15, wherein a radius of curvature of the substantially perfectly round circle a, a radius of curvature of the substantially perfectly round circle b, and a radius of curvature of the substantially perfectly round circle c are equal.

17. The ring-shaped light emitting unit according to claim 15, wherein all of a distance between the center of the substantially perfectly round circle a and the center of the inner periphery, a distance between the center of the substantially perfectly round circle b and the center of the inner periphery, and a distance between the center of the substantially perfectly round circle c and the center of the inner periphery are 2% to 15% with respect to 100% of a radius of the inner periphery.
